(19) United States
(12) Patent Application Publication
(10) Pub. No.: US 2025/0037124 A1
(43) Pub. Date: Jan. 30, 2025

(54) METHOD FOR EXTRACTING AND PARSING BITCOIN TRANSACTION AUTONOMY INFORMATION

(71) Applicant: TIANJIN UNIVERSITY OF TECHNOLOGY, Tianjin (CN)

(72) Inventors: Jinsong WANG, Tianjin (CN); Zening ZHAO, Tianjin (CN); Kai SHI, Tianjin (CN)

(73) Assignee: TIANJIN UNIVERSITY OF TECHNOLOGY, Tianjin (CN)

(21) Appl. No.: 18/709,031

(22) PCT Filed: Jul. 21, 2023
(86) PCT No.: PCT/CN2023/108600

§ 371 Date: May 10, 2024

(30) Foreign Application Priority Data
Jul. 25, 2022 (CN) 202210878845.5

(51) Int. Cl. G06Q 20/40

(52) U.S. Cl. CPC G06Q 20/401; G06Q 2220/00

(57) ABSTRACT

A method for extracting and parsing Bitcoin transaction autonomy information comprises data extraction, transaction autonomy information extraction, feature extraction, information decoding, information cleaning, information fusion, and data table construction. The method has the following beneficial effects. 1. Universality: This method is applicable to mainstream blockchain systems such as Ethereum, EOS, Polkadot, and Fabric through analysis of the current architecture of blockchain technology. 2. Effectiveness: Taking the relationship between emotional tendency of transaction autonomy information and price changes as an example, a generated dataset shows good performance in monitoring online public opinions. 3. Progressiveness: This method for extracting and parsing Bitcoin transaction autonomy information is helpful for implementing public opinion monitoring in blockchain systems, enhancing cybersecurity, and improving the level of information analysis.

### TECHNICAL FIELD

The invention belongs to the technical field of blockchain data mining, and particularly relates to a method for extracting and parsing Bitcoin transaction autonomy information.

### BACKGROUND ART

With the development of blockchain technology, public chains are frequently exploited for illicit financial activities due to their decentralized nature and challenging regulation. Conventional blockchain monitoring techniques primarily center on tracking transactions through methods like address clustering and graphical methods, placing greater emphasis on transaction behavior relationships between users, while overlooking abnormal information in individual transactions. In blockchain systems, users can add autonomous transaction information in addition to conducting transactions, which may contain any type of content. including online public opinion information. However, there is currently no effective method to extract and parse such information.

There are several traditional blockchain monitoring techniques.
(1) Address clustering-based blockchain monitoring method: Bitcoin adopts the UTXO model, allowing a single tangible user to have multiple transaction addresses in the network. As for address clustering for tangible users, identifying which addresses belong to the same entity from abnormal transaction records is a critical issue.
(2) Graph matching-based blockchain monitoring method: Two abnormal transaction behaviors, namely candy airdrop and greedy capital injection, are used as typical representatives, and rules for assessing these two behaviors are designed accordingly.
(3) Complex network-based blockchain monitoring method: Complex network analysis techniques are used to study the Bitcoin transaction network, particularly the effective use of community detection to re-identify multiple addresses belonging to the same user.

Traditional blockchain monitoring techniques focus on transaction relationships between blockchain users and do not analyze information unrelated to transactions between users. Recent blockchain messaging incidents highlight the importance of detecting and analyzing blockchain transaction data for public opinion monitoring on the blockchain, which is a significant research area in blockchain data mining.

### SUMMARY OF THE INVENTION

In order to solve the above problems, the invention aims to provide a method for extracting and parsing Bitcoin transaction autonomy information.

In order to achieve the above objectives, the method for extracting and parsing Bitcoin transaction autonomy information provided by the invention comprises the following steps in sequence:
(1) building a Bitcoin client and synchronizing original block stream data to a local area; then parsing and structuring the original block stream data to obtain Bitcoin structured data; and then obtaining an output script of each transaction from the Bitcoin structured data;
(2) verifying the validity of the transaction output script by using a transaction script verification algorithm Algorithmₜₑₛₜ; determining that the transaction is true and valid and does not contain any transaction autonomy information if the verification succeeds; and returning transaction autonomy information Tx_{information} if the verification fails;
(3) extracting blockchain features from the transaction autonomy information Tx_{information}, and then constructing a transaction autonomy information data table by using the transaction autonomy information and the blockchain features;
(4) sequentially reading the transaction autonomy information Tx_{information} from the transaction autonomy information data table, and decoding the transaction autonomy information Tx_{information} by using a transaction autonomy information decoding algorithm Algorithm_{code_recognition} to obtain decoded information Information_{decode}; and then inserting the decoded information Information_{decode} into the transaction autonomy information data table as features;
(5) cleaning the decoded information Information_{decode} by feature extraction and identification, marking decodable signs Sign_{decode} of decoded information Information_{decode} which is successfully decoded as 1, and decodable signs Sign_{decode} of other decoded information as 0, and inserting the decodable signs Sign_{decode} into the transaction autonomy information data table as features;
(6) determining the fusion possibility of successfully decoded transaction autonomy information Information_{decode} by using an information fusion algorithm Algorithm_{address_association} based on transaction address association analysis, and fusing fusible transaction autonomy information Information_{decode} to form fused information Information_{related}; and
(7) extracting an information ID info_{id} before fusion from the fused information Information_{related}, and constructing a transaction autonomy information fusion information data table.

The step (1) of, building a Bitcoin client and synchronizing original block stream data to a local area; then parsing and structuring the original block stream data to obtain Bitcoin structured data; and then obtaining an output script of each transaction from the Bitcoin structured data, specifically comprises:
building a Bitcoin client Bitcoin Core, and synchronizing original block stream data Dt to a local area; parsing and structuring the original block stream data Dt to obtain Bitcoin structured data St, wherein the original block stream data Dt represent all block data of the Bitcoin system up to time t, and the Bitcoin structured data St are obtained by processing the block data before time t, including block size BTC_Block_{size} and transaction list Tx_List; then, searching the transaction list Tx List in the bitcoin structured data St to output a script field in array Outputs; and finally obtaining an output script of each transaction Tx_{script}^{out}.

The step (2) of, extracting transaction autonomy information by using a transaction script verification algorithm Algorithmₜₑₛₜ, specifically comprises:
(201) converting the transaction output script Tx_{script}^{out} from a string format to a binary byte stream Scirpt_{bytearray};
(202) initializing an empty stack data structure;
(203) reading a byte from the binary byte stream Scirpt_{bytearray}; and deleting the byte from the binary byte stream Scirpt_{bytearray};
(204) converting the byte into a Bitcoin operation code Op_code:
(205) putting the Bitcoin operation code OP_code into a stack;
(206) acquiring a stack top Bitcoin operation code OP_code, and operating the stack according to the stack top Bitcoin operation code Op_code;
(207) if the stack top Bitcoin operation code Op_code has subsequent input parameters, reading a corresponding number of bytes Bytes from the binary byte stream Scirpt_{bytearray};
(208) putting the number of bytes Bytes into the stack;
(209) repeating (203) to (208) until the binary byte stream Scirpt_{bytearray} is empty; and
(210) verifying a stack top element; if the top stack element is a Boolean type True, determining that the transaction output script verification succeeds; if the top stack element is a Boolean type False, determining that the transaction output script verification fails; and if the top stack element is not a Boolean type, determining that it is the extracted transaction autonomy information Tx_{information}, which will still be preserved on the blockchain, wherein corresponding unspent coins will be transferred to miners.

The step (3) of, extracting blockchain features from the transaction autonomy information Tx_{information}, and then constructing a transaction autonomy information data table by using the transaction autonomy information and the blockchain features, specifically comprises:
extracting blockchain features from the transaction autonomy information Tx_{information}: ID Block_{id}, block hash Blockₕₐₛₕ, transaction version Blockᵥₑᵣₛᵢₒₙ, block height Block_{number}, block generation time Blockₜᵢₘₑₛₜₐₘₚ, transaction hash Block_{this_txhash}, input script transaction hash Block_{input_txhash}, input value Block_{input_value}, input address Block_{input_address}, miner's fee Block_{fee}, output script Block_{output_script_asm}, ASCII script Block_{output_script_asc} and decoded output script Block_{output_script_decode}; and then constructing a transaction autonomy information data table by using the transaction autonomy information and the blockchain features.

The step (4) of, decoding the transaction autonomy information Tx_{information} by using a transaction autonomy information decoding algorithm Algorithm_{code_recognition} to obtain decoded information Information_{decode}, specifically comprises:
(401) constructing an encoding table Code_{info} by using known transaction autonomy information encoding rules;
(402) reading a piece of transaction autonomy information Tx_{information} in the transaction autonomy information data table;
(403) reading the first two digits of a hexadecimal string of the transaction autonomy information Tx_{information}, and converting the same into a character Char_{bytes} according to a hexadecimal integer;
(404) determining whether the character Char_{bytes} is a natural language character; if so, proceeding to (405); otherwise, proceeding to (406);
(405) executing (410) until the hexadecimal string of the transaction autonomy information Tx_{information} is empty, and finally obtaining decoded information Information_{decode} of the transaction autonomy information Tx_{information};
(406) continuing to read the first two digits of the hexadecimal string of the transaction autonomy information Tx_{information}, and searching the coding table Code_{info} for decoding rules for a four-digit hexadecimal integer according to Unicode coding rules; if found, proceeding to (407); otherwise, proceeding to (408);
(407) decoding according to the coding table Code_{info} and marking a coding language of the transaction autonomy information; repeating (403) until the hexadecimal string of the transaction autonomy information Tx_{information} is empty; and finally obtaining the decoded information Information_{decode} of the transaction autonomy information Tx_{information};
(408) marking the transaction autonomy information Tx_{information} as undecodable;
(409) inserting the decoded information Information_{decode} into the transaction autonomy information data table as features, and if the transaction autonomy information is undecodable, inserting the transaction autonomy information Tx_{information}; and
(410) repeating (402) to (409) until all transaction autonomy information Tx_{information} is decoded.

The step (6) of, using an information fusion algorithm Algorithm_{address_association} based on transaction address association analysis to determine the fusion possibility of successfully decoded autonomy information data Information_{decode}, and fusing fusible autonomy information data Information_{decode} to form fused information Information_{related}, specifically comprises:
(601) inputting decoded information Information_{decode} of a piece of transaction autonomy information;
(602) determining whether the decoded information Information_{decode} is fusible information by using a fusible information identification algorithm Algorithm_{is_fusible}; if so, proceeding to (603); otherwise, proceeding to (606);
(603) if the information is backward fusion information, proceeding to (604); if the information is forward fusion information, proceeding to (605); if the information is not fusible information, proceeding to (606);
(604) reading an input script transaction hash Block_{input_txhash} of the decoded information in the transaction autonomy information data table generated in step (3), determining whether there is fusible information in the output of the transaction, and if so, conducting information fusion to generate fused information Information_{related}; then proceeding to (606);
(605) reading a transaction hash Block_{this_txhash} of the decoded information in the transaction autonomy information data table generated in step (3), determining if there is fusible information using the transaction hash as an input script transaction hash Block_{input_txhash}, and if so, performing information fusion to generate fused information Information_{related}; and
(606) repeating (601) to (605) until the decoded information of all transaction autonomy information is fused.

The step (602) of, determining whether the decoded information Information_{decode} is fusible information by using a fusible information identification algorithm Algorithm_{is_fusible}, specifically comprises:
(60201) initializing a table of characters to be matched, which contains flag bits of each character to be matched, wherein the flag bits of all characters have a value of 0;
(60202) inputting decoded information Information_{decode} of a piece of transaction autonomy information;
(60203) reading a character from the decoded information Information_{decode}, and determining whether the character is a character to be matched; if so, proceeding to (60204); otherwise, proceeding to (60205);
(60204) determining whether the character is a start character or an end character; if it is a start character, incrementing the flag bit value of the character to be matched in the table of characters to be matched by 1; if it is an end character, decrementing the flag bit value of the character to be matched by 1; if it is neither a start character nor an end character, performing no operation;
(60205) repeating (60202) to (60204) until the decoded information Information_{decode} is empty; and
(60206) determining that the decoded information is not fusible information if the flag bit values of all the characters to be matched are 0; determining that the decoded information is not fusible information if the flag bit values of some of the characters to be matched are positive and those of some characters to be matched are negative; determining that the decoded information is backward fusible information if the flag bit values of some of the characters to be matched are positive and those of other characters are 0, and returning to the table of characters to be matched; and determining that the decoded information is forward fusible information if the flag bit values of some of the characters to be matched are negative and those of other characters are 0, and returning to the table of characters to be matched.

The beneficial effects of the method for extracting and parsing Bitcoin transaction autonomy information provided by the present invention are as follows.
1. Universality: This method is applicable to mainstream blockchain systems such as Ethereum, EOS, Polkadot, and Fabric through analysis of the current architecture of blockchain technology.
2. Effectiveness: Taking the relationship between emotional tendency of transaction autonomy information and price changes as an example, a generated dataset shows good performance in monitoring online public opinions.
3. Progressiveness: This method for extracting and parsing Bitcoin transaction autonomy information is helpful for implementing public opinion monitoring in blockchain systems, enhancing cybersecurity, and improving the level of information analysis.

### BRIEF DESCRIPTION OF THE DRAWINGS

FIG. 1 is a flowchart of a method for extracting and parsing Bitcoin transaction autonomy information provided by the present invention;

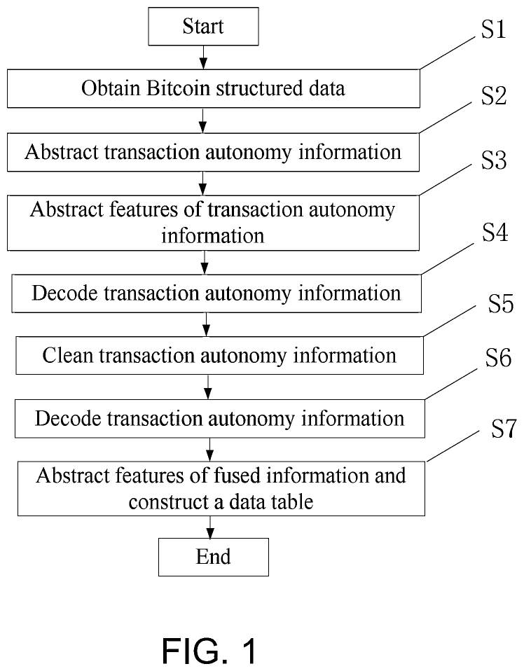

FIG. 2 is a process flow diagram of a transaction script verification algorithm in the present invention;

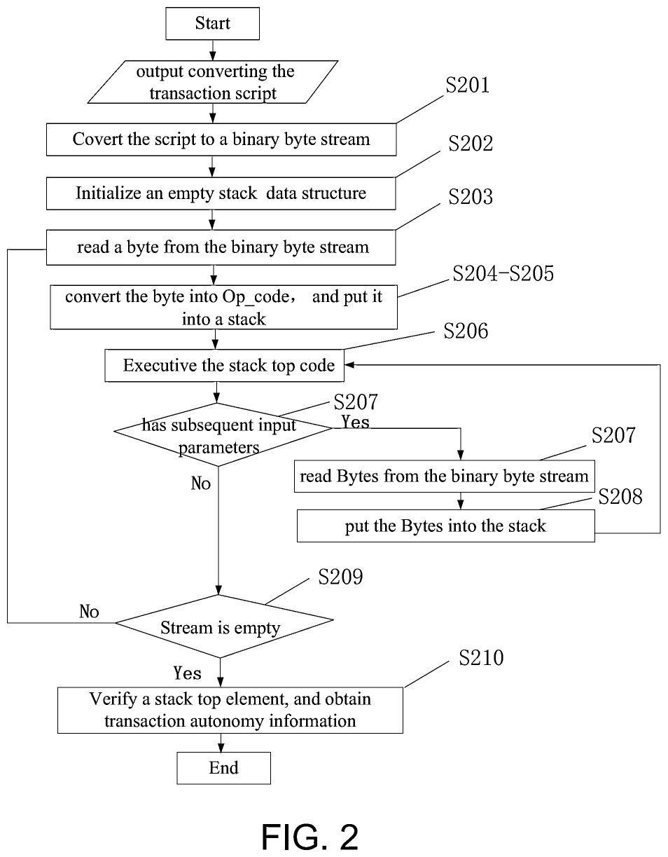

FIG. 3 is a process flow diagram of a transaction autonomy information code identification algorithm in the present invention;

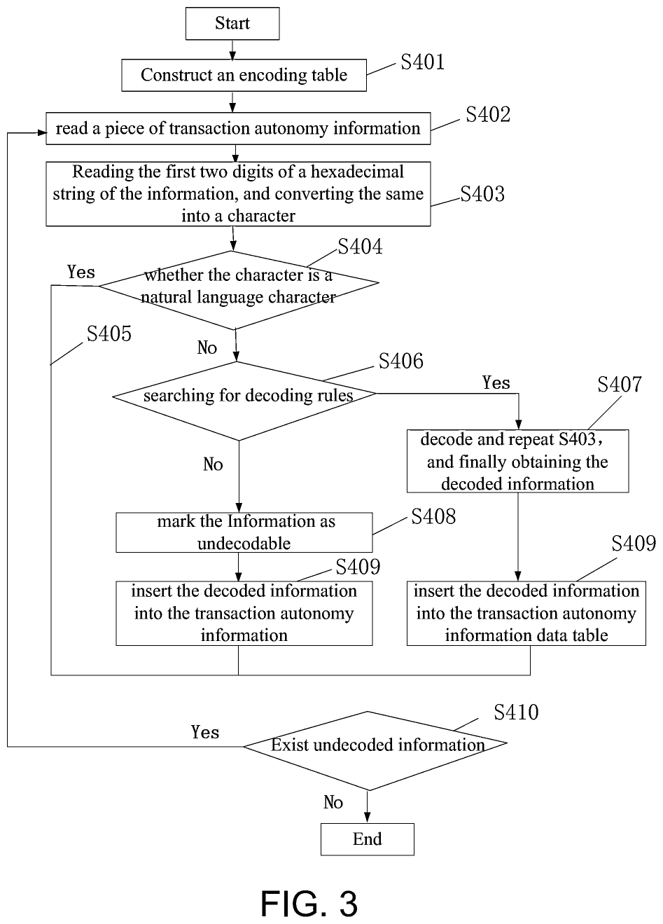

FIG. 4 is a process flow diagram of an information fusion algorithm based on transaction address association analysis in the present invention; and

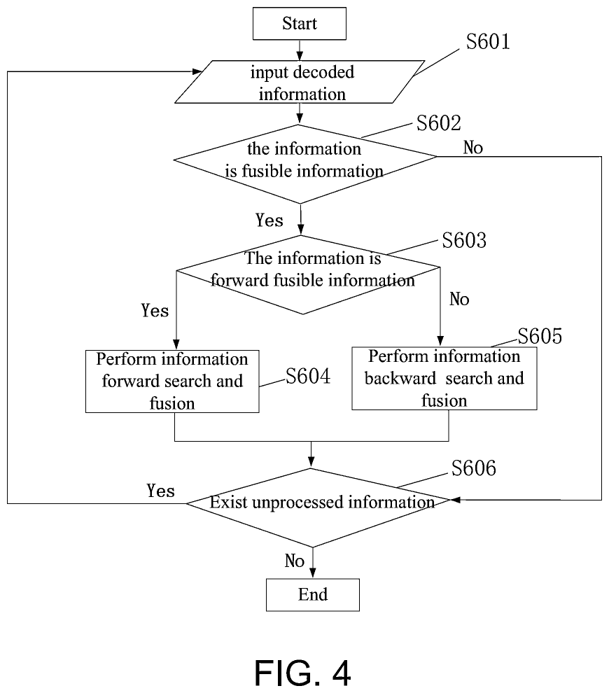

FIG. 5 is a process flow diagram of a fusible information identification algorithm in the present invention.

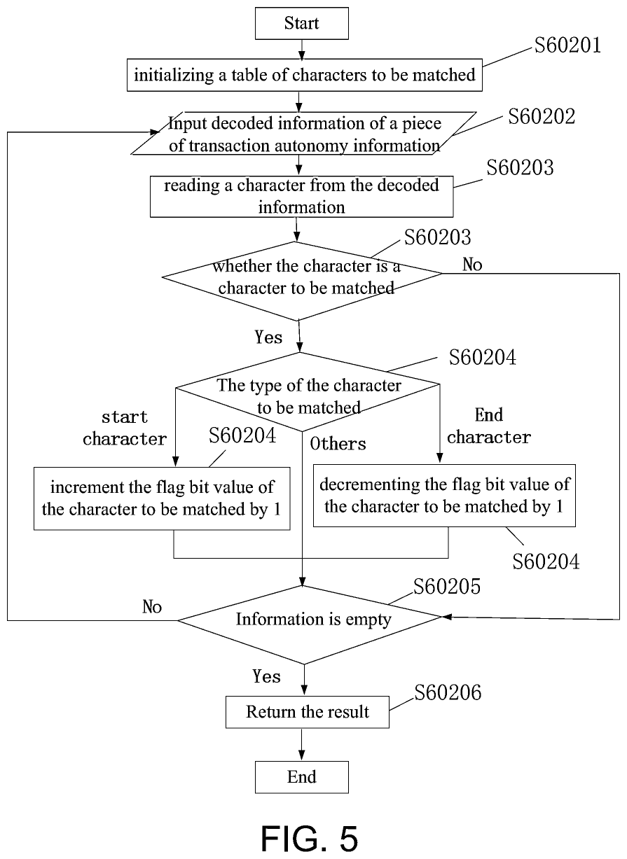

### DETAILED DESCRIPTION OF THE INVENTION

Specific embodiments will be provided below for further explanation of the present invention.

A method for extracting and parsing Bitcoin transaction autonomy information provided by the invention comprises the following steps in sequence:
(1) building a Bitcoin client and synchronizing original block stream data to a local area; then parsing and structuring the original block stream data to obtain Bitcoin structured data; and then obtaining an output script of each transaction from the Bitcoin structured data; specifically comprising:
building a Bitcoin client Bitcoin Core, and synchronizing original block stream data Dt to a local area; parsing and structuring the original block stream data Dt to obtain Bitcoin structured data St, wherein the original block stream data Dt represent all block data of the Bitcoin system up to time t, and the Bitcoin structured data St are obtained by processing the block data before time t, including block size BTC_Block_{size} and transaction list Tx_List; then, searching for the transaction list Tx List in the bitcoin structured data St to output a script field in array Outputs; and finally obtaining an output script of each transaction Tx_{script}^{out};
(2) verifying the validity of the transaction output script by using a transaction script verification algorithm Algorithmₜₑₛₜ; determining that the transaction is true and valid and does not contain any transaction autonomy information if the verification succeeds; and returning transaction autonomy information Tx_{information} if the verification fails;
specifically comprising:
(201) converting the transaction output script Tx_{script}^{out} from a string format to a binary byte stream Scirpt_{bytearray};
(202) initializing an empty stack data structure;
(203) reading a byte from the binary byte stream Scirpt_{bytearray} and deleting the byte from the binary byte stream Scirpt_{bytearray};
(204) converting the byte into a Bitcoin operation code Op_code:
(205) putting the Bitcoin operation code OP_code into a stack;
(206) acquiring a stack top Bitcoin operation code OP_code, and operating the stack according to the stack top Bitcoin operation code Op_code;
(207) if the stack top Bitcoin operation code Op_code has subsequent input parameters. reading a corresponding number of bytes Bytes from the binary byte stream Scirpt_{bytearray};
(208) putting the number of bytes Bytes into the stack:
(209) repeating (203) to (208) until the binary byte stream Scirpt_{bytearray} is empty; and
(210) verifying a stack top element; if the top stack element is a Boolean type True, determining that the transaction output script verification succeeds; if the top stack element is a Boolean type False, determining that the transaction output script verification fails; and if the top stack element is not a Boolean type, determining that it is the extracted transaction autonomy information Tx_{information}, which will still be preserved on the blockchain, wherein corresponding unspent coins will be transferred to miners;
(3) extracting blockchain features from the transaction autonomy information Tx_{information}, and then constructing a transaction autonomy information data table by using the transaction autonomy information and the blockchain features;
specifically comprising:
extracting blockchain features from the transaction autonomy information Tx_{information}: ID Block_{id}, block hash Blockₕₐₛₕ, transaction version Blockᵥₑᵣₛᵢₒₙ, block height Block_{number}, block generation time Blockₜᵢₘₑₛₜₐₘₚ, transaction hash Block_{this_txhash}, input script transaction hash Block_{input_txhash}, input value Block_{input_value}, input address Block_{input_address}, miner's fee Block_{fee}, output script Block_{output_script_asm}, ASCII script Block_{output_script_asc} and decoded output script Block_{output_script_decode}; and then constructing a transaction autonomy information data table by using the transaction autonomy information and the blockchain features;
(4) sequentially reading the transaction autonomy information Tx_{information} from the transaction autonomy information data table, and decoding the transaction autonomy information Tx_{information} by using a transaction autonomy information decoding algorithm Algorithm_{code_recognition} to obtain decoded information Information_{decode}; and then inserting the decoded information Information_{decode} into the transaction autonomy information data table as features;
specifically comprising:
(401) constructing an encoding table Code_{info} by using known transaction autonomy information encoding rules;
(402) reading a piece of transaction autonomy information Tx_{information} in the transaction autonomy information data table;
(403) reading the first two digits of a hexadecimal string of the transaction autonomy information Tx_{information}, and converting the same into a character Char_{bytes} according to a hexadecimal integer;
(404) determining whether the character Char_{bytes} is a natural language character; if so, proceeding to (405); otherwise, proceeding to (406);
(405) executing (410) until the hexadecimal string of the transaction autonomy information Tx_{information} is empty, and finally obtaining decoded information Information_{decode} of the transaction autonomy information Tx_{information};
(406) continuing to read the first two digits of the hexadecimal string of the transaction autonomy information Tx_{information}, and searching the coding table Code_{info} for decoding rules for a four-digit hexadecimal integer according to Unicode coding rules; if found, proceeding to (407); otherwise, proceeding to (408);
(407) decoding according to the coding table Code_{info} and marking a coding language of the transaction autonomy information; repeating (403) until the hexadecimal string of the transaction autonomy information Tx_{information} is empty; and finally obtaining the decoded information Information_{decode} of the transaction autonomy information Tx_{information};
(408) marking the transaction autonomy information Tx_{information} as undecodable;
(409) inserting the decoded information Information_{decode} into the transaction autonomy information data table as features, and if the transaction autonomy information is undecodable, inserting the transaction autonomy information Tx_{information}; and
(410) repeating (402) to (409) until all transaction autonomy information Tx_{information} is decoded;
(5) cleaning the decoded information Information_{decode} by feature extraction and identification, marking decodable signs Sign_{decode} of decoded information Information_{decode} which is successfully decoded as 1, and decodable signs Sign_{decode} of other decoded information as 0, and inserting the decodable signs Sign_{decode} into the transaction autonomy information data table as features;
(6) determining the fusion possibility of successfully decoded transaction autonomy information Information_{decode} by using an information fusion algorithm Algorithm_{address_association} based on transaction address association analysis, and fusing fusible transaction autonomy information Information_{decode} to form fused information Information_{decode};
specifically comprising:
(601) inputting decoded information Information_{decode} of a piece of transaction autonomy information;
(602) determining whether the decoded information Information_{decode} is fusible information by using a fusible information identification algorithm Algorithm_{is_fusible}; if so, proceeding to (603); otherwise, proceeding to (606);
(603) if the information is backward fusion information, proceeding to (604); if the information is forward fusion information, proceeding to (605); if the information is not fusible information, proceeding to (606);
(604) reading an input script transaction hash Block_{input_txhash} of the decoded information in the transaction autonomy information data table generated in step (3), determining whether there is fusible information in the output of the transaction, and if so, conducting information fusion to generate fused information Information_{related}; then proceeding to (606);
(605) reading a transaction hash Block_{this_txhash} of the decoded information in the transaction autonomy information data table generated in step (3), determining if there is fusible information using the transaction hash as an input script transaction hash Block_{input_address}, and if so, performing information fusion to generate fused information Information_{related}; and
(606) repeating (601) to (605) until the decoded information of all transaction autonomy information is fused;
wherein the step (602) of, determining whether the decoded information Information_{decode} is fusible information by using a fusible information identification algorithm Algorithm_{is_fusible}, specifically comprises:
(60201) initializing a table of characters to be matched, which contains flag bits of each character to be matched, wherein the flag bits of all characters have a value of 0;
(60202) inputting decoded information Information_{decode} of a piece of transaction autonomy information;
(60203) reading a character from the decoded information Information_{decode}, and determining whether the character is a character to be matched; if so, proceeding to (60204); otherwise, proceeding to (60205);
(60204) determining whether the character is a start character or an end character; if it is a start character, incrementing the flag bit value of the character to be matched in the table of characters to be matched by 1; if it is an end character, decrementing the flag bit value of the character to be matched by 1; if it is neither a start character nor an end character, performing no operation;
(60205) repeating (60202) to (60204) until the decoded information Information_{decode} is empty; and
(60206) determining that the decoded information is not fusible information if the flag bit values of all the characters to be matched are 0; determining that the decoded information is not fusible information if the flag bit values of some of the characters to be matched are positive and those of some characters to be matched are negative; determining that the decoded information is backward fusible information if the flag bit values of some of the characters to be matched are positive and those of other characters are 0, and returning to the table of characters to be matched; and determining that the decoded information is forward fusible information if the flag bit values of some of the characters to be matched are negative and those of other characters are 0, and returning to the table of characters to be matched; and
(7) extracting an information ID info_{id} before fusion from the fused information Information_{related}, and constructing a transaction autonomy information fusion information data table.

1. A method for extracting and parsing Bitcoin transaction autonomy information, includes the following steps in sequence:
(1) building a Bitcoin client and synchronizing original block stream data to a local area; then parsing and structuring the original block stream data to obtain Bitcoin structured data; and then obtaining an output script of each transaction from the Bitcoin structured data;
(2) verifying a validity of the transaction output script by using a transaction script verification algorithm Algorithmₜₑₛₜ; determining that the transaction is true and valid and does not contain any transaction autonomy information if the verification succeeds; and returning transaction autonomy information Tx_{information} if the verification fails;
(3) extracting blockchain features from the transaction autonomy information Tx_{information}, and then constructing a transaction autonomy information data table by using the transaction autonomy information and the blockchain features;
(4) sequentially reading the transaction autonomy information Tx_{information} from the transaction autonomy information data table, and decoding the transaction autonomy information Tx_{information} by using a transaction autonomy information decoding algorithm Algorithm_{code_recognition} to obtain decoded information Information_{decode}; and then inserting the decoded information Information_{decode} into the transaction autonomy information data table as features;
(5) cleaning the decoded information Information_{decode} by feature extraction and identification, marking decodable signs Sign_{decode} of the decoded information Information_{decode} which is successfully decoded as 1, and decodable signs Sign_{decode} of other decoded information as 0, and inserting the decodable signs Sign_{decode} into the transaction autonomy information data table as features;
(6) determining a fusion possibility of successfully decoded transaction autonomy information Information_{decode} by using an information fusion algorithm Algorithm_{address_association} based on transaction address association analysis, and fusing fusible transaction autonomy information Information_{decode} to form fused information Information_{related}; and
(7) extracting an information ID info_{id} before fusion from the fused information Information_{related}, and constructing a transaction autonomy information fusion information data table.

2. The method for extracting and parsing Bitcoin transaction autonomy information of claim 1, wherein the step (1) of, building the Bitcoin client and synchronizing the original block stream data to the local area; then parsing and structuring the original block stream data to obtain the Bitcoin structured data; and then obtaining the output script of each transaction from the Bitcoin structured data, specifically comprises:
building a Bitcoin client Bitcoin Core, and synchronizing original block stream data Dt to the local area; parsing and structuring the original block stream data Dt to obtain Bitcoin structured data St, wherein the original block stream data Dt represent all block data of the Bitcoin system up to time t, and the Bitcoin structured data St are obtained by processing the block data before time t, including block size BTC_Block_{size} and transaction list Tx_List; then, searching the transaction list Tx_List in the bitcoin structured data St to output a script field in array Outputs; and finally obtaining an output script of each transaction Tx_{script}^{out}.

3. The method for extracting and parsing Bitcoin transaction autonomy information of claim 1, wherein the step (2) of, extracting transaction autonomy information by using the transaction script verification algorithm Algorithmₜₑₛₜ, specifically comprises:
(201) converting the transaction output script Tx_{script}^{put} from a string format to a binary byte stream Scirpt_{bytearray};
(202) initializing an empty stack data structure;
(203) reading a byte from the binary byte stream Scirpt_{bytearray}; and deleting the byte from the binary byte stream Scirpt_{bytearray};
(204) converting the byte into a Bitcoin operation code Op_code;
(205) putting the Bitcoin operation code OP_code into a stack;
(206) acquiring a stack top Bitcoin operation code OP_code, and operating the stack according to the stack top Bitcoin operation code Op_code;
(207) if the stack top Bitcoin operation code Op_code has subsequent input parameters, reading a corresponding number of bytes Bytes from the binary byte stream Scirpt_{bytearray};
(208) putting the number of bytes Bytes into the stack;
(209) repeating (203) to (208) until the binary byte stream Scirpt_{bytearray} is empty; and
(210) verifying a stack top element; if the top stack element is a Boolean type True, determining that the transaction output script verification succeeds; if the top stack element is a Boolean type False, determining that the transaction output script verification fails; and if the top stack element is not a Boolean type, determining that it is the extracted transaction autonomy information Tx_{information}, which will still be preserved on the blockchain, wherein corresponding unspent coins will be transferred to miners.

4. The method for extracting and parsing Bitcoin transaction autonomy information of claim 1, wherein the step (3) of, extracting blockchain features from the transaction autonomy information Tx_{information}, and then constructing a transaction autonomy information data table by using the transaction autonomy information and the blockchain features, specifically comprises:
extracting blockchain features from the transaction autonomy information Tx_{information}: ID Block_{id}, block hash Blockₕₐₛₕ, transaction version Blockᵥₑᵣₛᵢₒₙ, block height Block_{number}, block generation time Blockₜᵢₘₑₛₜₐₘₚ, transaction hash Block_{this_txhash}, input script transaction hash Block_{input_txhash}, input value Block_{input_value}, input address Block_{input_address}, miner's fee Block_{fee}, output script Block_{output_script_asm}, ASCII script Block_{output_script_asc} and decoded output script Block_{output_script_decode}; and then constructing the transaction autonomy information data table by using the transaction autonomy information and the blockchain features.

5. The method for extracting and parsing Bitcoin transaction autonomy information of claim 1, wherein the step (4) of, decoding the transaction autonomy information Tx_{information} by using the transaction autonomy information decoding algorithm Algorithm_{code_recognition} to obtain the decoded information Information_{decode}, specifically comprises:
(401) constructing an encoding table Code_{info} by using known transaction autonomy information encoding rules;
(402) reading a piece of transaction autonomy information Tx_{information} in the transaction autonomy information data table;
(403) reading the first two digits of a hexadecimal string of the transaction autonomy information Tx_{information}, and converting the same into a character Char_{bytes} according to a hexadecimal integer;
(404) determining whether the character Char_{bytes} is a natural language character; if so, proceeding to (405); otherwise, proceeding to (406);
(405) executing (410) until the hexadecimal string of the transaction autonomy information Tx_{information} is empty, and finally obtaining decoded information Information_{decode} of the transaction autonomy information Tx_{information};
(406) continuing to read the first two digits of the hexadecimal string of the transaction autonomy information Tx_{information}, and searching the coding table Code_{info} for decoding rules for a four-digit hexadecimal integer according to Unicode coding rules; if found, proceeding to (407); otherwise, proceeding to (408);
(407) decoding according to the coding table Code_{info} and marking a coding language of the transaction autonomy information; repeating (403) until the hexadecimal string of the transaction autonomy information Tx_{information} is empty; and finally obtaining the decoded information Information_{decode} of the transaction autonomy information Tx_{information};
(408) marking the transaction autonomy information Tx_{information} as undecodable;
(409) inserting the decoded information Information_{decode} into the transaction autonomy information data table as features, and if the transaction autonomy information is undecodable, inserting the transaction autonomy information Tx_{information}; and
(410) repeating (402) to (409) until all transaction autonomy information Tx_{information} is decoded.

6. The method for extracting and parsing Bitcoin transaction autonomy information of claim 1, wherein the step (6) of, using the information fusion algorithm Algorithm_{address_association} based on transaction address association analysis to determine the fusion possibility of successfully decoded autonomy information data Information_{decode}, and fusing the fusible autonomy information data Information_{decode} to form fused information Information_{related}, specifically comprises:
(601) inputting the decoded information Information_{decode} of a piece of transaction autonomy information;
(602) determining whether the decoded information Information_{decode} is fusible information by using a fusible information identification algorithm Algorithm_{is_fusible}; if so, proceeding to (603); otherwise, proceeding to (606);
(603) if the information is backward fusion information, proceeding to (604); if the information is forward fusion information, proceeding to (605); if the information is not fusible information, proceeding to (606);
(604) reading an input script transaction hash Block_{input_txhash} of the decoded information in the transaction autonomy information data table generated in step (3), determining whether there is fusible information in the output of the transaction, and if so, conducting information fusion to generate fused information Information_{related}; then proceeding to (606);
(605) reading a transaction hash Block_{this_txhash} of the decoded information in the transaction autonomy information data table generated in step (3), determining if there is fusible information using the transaction hash as an input script transaction hash Block_{input_txhash}, and if so, performing information fusion to generate fused information Information_{related}; and
(606) repeating (601) to (605) until the decoded information of all transaction autonomy information is fused.

7. The method for extracting and parsing Bitcoin transaction autonomy information of claim 6, wherein the step (602) of, determining whether the decoded information Information_{decode} is fusible information by using the fusible information identification algorithm Algorithm_{is_fusible}, specifically comprises:
(60201) initializing a table of characters to be matched, which contains flag bits of each character to be matched, wherein the flag bits of all characters have a value of 0;
(60202) inputting decoded information Information_{decode} of a piece of transaction autonomy information;
(60203) reading a character from the decoded information Information_{decode}, and determining whether the character is a character to be matched: if so, proceeding to (60204); otherwise, proceeding to (60205);
(60204) determining whether the character is a start character or an end character; if it is a start character, incrementing the flag bit value of the character to be matched in the table of characters to be matched by 1; if it is an end character, decrementing the flag bit value of the character to be matched by 1; if it is neither a start character nor an end character, performing no operation;
(60205) repeating (60202) to (60204) until the decoded information Information_{decode} is empty; and
(60206) determining that the decoded information is not fusible information if the flag bit values of all the characters to be matched are 0; determining that the decoded information is not fusible information if the flag bit values of some of the characters to be matched are positive and those of some characters to be matched are negative; determining that the decoded information is backward fusible information if the flag bit values of some of the characters to be matched are positive and those of other characters are 0, and returning to the table of characters to be matched; and determining that the decoded information is forward fusible information if the flag bit values of some of the characters to be matched are negative and those of other characters are 0, and returning to the table of characters to be matched.
